(19) United States
(12) Patent Application Publication
(10) Pub. No.: US 2020/0393538 A1
(43) Pub. Date: Dec. 17, 2020

(54) Depth Sensor, Detection System, And Method for Controlling A Transmit Power of The Depth Sensor

(71) Applicant: Wu Qi Technologies, Inc., Yubei District, Chonnging (CN)

(72) Inventor: Bairu CHEN, Yubei District, Chongqing (CN)

(21) Appl. No.: 16/327,919

(22) PCT Filed: Mar. 19, 2018
(86) PCT No.: PCT/CN2018/079431

§ 371 Date: Feb. 25, 2019

(30) Foreign Application Priority Data
Dec. 22, 2017 (CN) 201711404639.6

(51) Int. Cl. G01S 7/40; G01S 13/08

(52) U.S. Cl. CPC G01S 7/4008; G01S 2007/4013; G01S 13/08

(57) ABSTRACT

A depth sensor, a detection system, and a method for controlling a transmit power of the depth sensor are provided, wherein the control method comprises procedures of: obtaining priori information of a to-be-measured working environment; presetting priori information of the to-be-measured working environment; working out position information and orientation information of the active sensor based on the preset priori information of the to-be-measured working environment and detected information; and working out a maximum transmit power based on the position information and the orientation information of the active sensor and correspondingly dynamically adjusting the transmit power of the active depth sensor based on the maximum transmit power. The present disclosure has advantages of smartly and dynamically adjusting the transmit power and reducing power consumption of a device with the active depth sensor.

### FIELD

Embodiments of the present disclosure generally relate to the field of detection technologies of sensors, and more particularly to an active depth sensor, a detection system, and a method for controlling a transmit power of the active depth sensor.

### BACKGROUND

A depth sensor provides, to a device, information related to a position and pose of a user and information related to a three-dimensional shape of a surrounding environment of the depth sensor. Depth sensors are divided into two classes: passive stereoscopic cameras and active stereoscopic cameras. A passive stereoscopic camera observes a scene with two or more cameras, and estimates a depth of the scene based on displacements of the features in a plurality of views of these cameras. An active depth camera projects invisible infrared light to a scene and estimates a depth of the scene based on reflected information.

In the field of artificial intelligence such as robots, unmanned drive, and smart hardware, it is a very important part to sense the environment using a sensor. A major class of active depth sensors, such as laser radars, millimeter-wave radars, structured-light depth sensors, ToF (Time of Flight) depth sensors, and supersonic wave radars, etc., can implement effective measurement of geometric dimensions of the physical world. All of such sensors need to emit a certain form of signals. The laser radar sensor, structured-light sensors, and ToF sensors all need to emit infrared or near-infrared light, the millimeter-wave radar emits electromagnetic wave in millimeter wave band, and the supersonic wave radar emits ultrasonic wave signals. However, all of these sensors need to consume a certain power. The farther the detection distance is, the more power is consumed. For many sensors mounted to mobile robots or mobile terminals, it is a very important requirement to control the transmit power and the overall power consumption under a precondition of implementing effective information measurement such as depth. A lower power consumption may enable a longer operating time with a same battery capacity. However, existing active depth sensors either have a fixed transmit power and overall power consumption or adopt a relatively simple power control solution. For example, they first work under a relatively low transmit power; without enough effective depth measurements being obtained, the transmit power will increase to a next preset value. Although this approach has a certain efficacy, there is still large room to improve.

### SUMMARY

An object of the present disclosure is to provide an active depth sensor, a detection system, and a method for controlling a transmit power of the active depth sensor, which achieves a purpose of reducing power consumption of a device equipped with the active depth sensor by smartly and dynamically adjusting and controlling the transmit power based on preset ambiance information.

To achieve the object above, the present disclosure is implemented through the following technical solutions:

A method for controlling a transmit power of an active depth sensor comprises the following procedures: obtaining priori information of a to-be-measured working environment; presetting priori information of the to-be-measured working environment; working out position information and orientation information of the active sensor based on the preset priori information of the to-be-measured working environment and detected information; and working out a maximum transmit power based on the position information and the orientation information of the active sensor and correspondingly dynamically adjusting the transmit power of the active depth sensor based on the maximum transmit power.

Preferably, the priori information of the to-be-measured working environment includes: map information of the working environment, wherein the map information includes: geographical information, depth information, and image information of the working environment.

Preferably, the detected information refers to feedback information real-time detected by the active sensor.

A second technical solution of the present disclosure provides an active sensor for implementing the method for controlling a transmit power of an active depth sensor, comprising: an acquiring module; a processing module preset with priori information of a to-be-measured working environment; and a control module connected to the acquiring module and the processing module, respectively; wherein the acquiring module is configured for obtaining, in real time, detected information of the to-be-measured working environment, and sending the detected information to the processing module; the processing module is configured for working out position information and orientation information of the active sensor based on the preset priori information of the to-be-measured working environment and the detected information, working out a maximum transmit power based on the position information and the orientation information of the active sensor, and sending the maximum transmit power to the control module, and the control module is configured for correspondingly dynamically adjusting the transmit power of the active depth sensor based on the maximum transmit power.

Preferably, the active sensor is applicable to a robot, an unmanned drive, and smart hardware.

A third technical solution of the present disclosure provides a detection system, comprising: at least one active sensor, a memory; one or more processors; and one or more programs, wherein the one or more programs are stored in the memory and configured to cause the one or more processors to perform the following steps: obtaining priori information of a to-be-measured working environment; presetting priori information of the to-be-measured working environment; working out position information and orientation information of the active sensor based on the preset priori information of the to-be-measured working environment and detected information; and working out a maximum transmit power based on the position information and the orientation information of the active sensor and correspondingly dynamically adjusting the transmit power of the active depth sensor based on the maximum transmit power.

Compared with the prior art, the present disclosure has the following advantages:

The present disclosure effectively controls the transmit power of the depth sensor based on preset environment-based geometric information and its own position/orientation information in conjunction with a performance curve of the depth sensor; compared with blindly working on a preset maximum transmit power in the prior art, the present disclosure may not only guarantee the performance of ambiance sensing, but also may reduce power consumption.

### BRIEF DESCRIPTION OF THE DRAWINGS

FIG. 1 shows a correspondence relationship between a maximum detection distance of a depth sensor and a transmit power;

FIG. 2 is a schematic diagram of a definition of a detection depth D of the depth sensor;

FIG. 3 is a schematic diagram of an embodiment of the detection depth D of the depth sensor in an environment with preset environmental geometrical information; and

FIG. 4 is a flow diagram of a method for controlling a transmit power of an active depth sensor.

### DETAILED DESCRIPTION OF EMBODIMENTS

Hereinafter, the present disclosure will be described in further detail through a preferred embodiment with reference to the accompanying drawings.

As shown in FIG. 4, an efficient power method for controlling an active depth sensor comprises procedures of: obtaining priori information of a to-be-measured working environment; presetting priori information of the to-be-measured working environment in the corresponding active depth sensor; working out, by the active depth sensor, position information and orientation information of the active sensor based on the preset priori information of the to-be-measured working environment and detected information real-time detected thereby; looking up a corresponding depth-power curve to work out a maximum transmit power, and then adjusting the transmit power thereof.

The active depth sensor above may be applied to a plurality of smart devices.

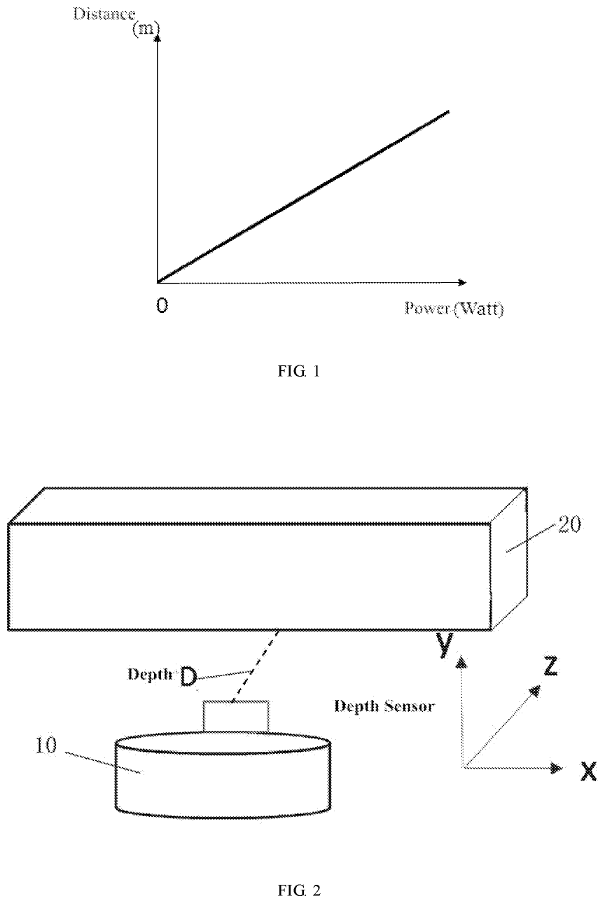

In conjunction with FIG. 1 and FIG. 2, a relationship between the transmit power W of the active depth sensor and a maximum valid detection depth D is obtained by calibration or by other means. FIG. 1 is a schematic diagram of an embodiment of a relationship between the transmit power W of the active depth sensor and the maximum valid detection depth D, wherein the relationship between the transmit power W and the maximum valid detection depth D assumes a directly proportional function relationship. The relationship curve between the actual transmit power W of the active depth sensor and the maximum valid detection depth D may assume different shapes. The relationship between the depth D and the power W is represented by a function D=f(W), units of which are meter and watt, respectively.

As shown in FIG. 2, the depth D is defined as such: supposing that the depth sensor establishes a three-dimensional coordinate system with a certain position of its own as an original, the three-dimensional coordinate system being a world coordinate system, then coordinate Z of any point in the world coordinate system at the FoV (Field of View) of the depth sensor is depth D. Some depth sensors may only measure the depth of a point on one plane, i.e., only having two coordinate axes X-Z, or Y-Z. By providing the depth sensor within a mobile robot 10, the detected straight-line distance between itself and the opposite wall body 20 thereof is its current detection depth D.

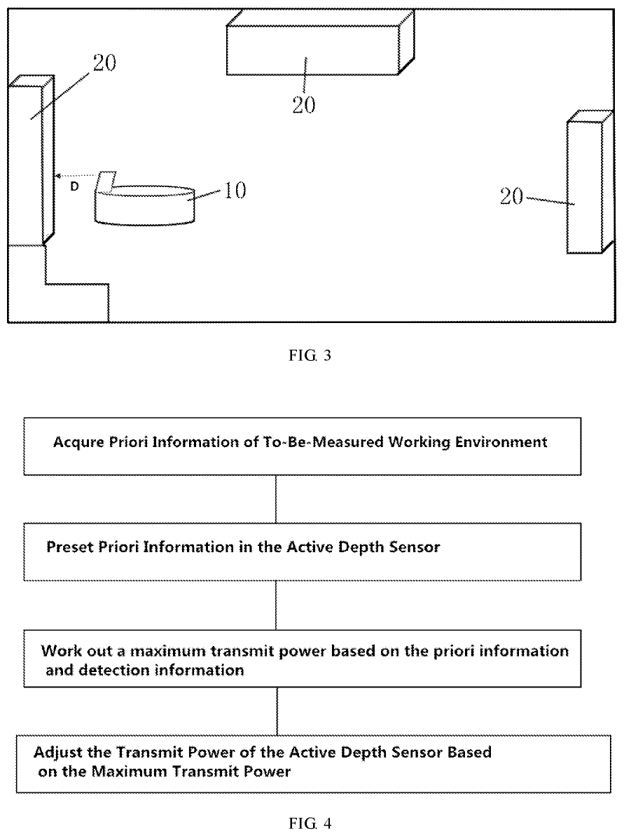

According to an embodiment of the present disclosure, as shown in FIG. 3, the mobile robot 10 is placed inside its working environment, and a plurality of barriers 20 are provided in the working environment, the barriers, including, but not limited to, indoor walls, other furniture placed inside the room. The mobile robot 10 pre-obtains map information of its working environment through a SLAM technology or other map constructing technology, wherein the map information includes depth information, working environment geometric information, and image information. During the subsequent working environment, the mobile robot 10 continuously performs determination of its own position. Suppose that the coordinate and orientation of the mobile robot in the current world coordinate system or a fixed coordinate system of the working environment have been determined. Then, the maximum depth of a marked point on the map within the FoV of the depth sensor is worked out using control software of the depth sensor based on the geometric information included in the map information of its working environment. With D representing this maximum depth, a depth-power curve is looked up to obtain the maximum transmit power required in the working environment. In actual use, factors such as a positioning error between the coordinate and the orientation, as well as emissivity of a surface of an object or building, may be further considered, in addition to a certain transmit power margin. If the estimated confidences of the current position and orientation are not high, a larger transmit power margin may be added to guarantee not to exceed the maximum transmit power of the depth sensor.

According to an embodiment of the present disclosure, the present disclosure further provides an active depth sensor, comprising: an acquiring module; a processing module preset with priori information of a to-be-measured working environment; and a control module connected to the acquiring module and the processing module, respectively; wherein the acquiring module is configured for obtaining, in real time, detected information of the to-be-measured working environment, and sending the detected information to the processing module; the processing module is configured for working out position information and orientation information of the active sensor based on the preset priori information of the to-be-measured working environment and the detected information, working out a maximum transmit power based on the position information and the orientation information of the active sensor, and sending the maximum transmit power to the control module; and the control module is configured for correspondingly dynamically adjusting the transmit power of the active depth sensor based on the maximum transmit power. The active sensor adjusts in real-time the transmit power of its own during working based on its own position information and orientation information.

According to an embodiment of the present disclosure, the present disclosure further discloses a detection system, comprising: at least one active sensor described above; a memory; one or more processors; and one or more programs, wherein the one or more programs are stored in the memory and configured to cause the one or more processors to perform the following steps: obtaining priori information of a to-be-measured working environment; presetting priori information of the to-be-measured working environment; working out position information and orientation information of the active sensor based on the preset priori information of the to-be-measured working environment and detected information; and working out a maximum transmit power based on the position information and the orientation information of the active sensor and correspondingly dynamically adjusting the transmit power of the active depth sensor based on the maximum transmit power.

Although the contents of the present disclosure have been described in detail through the foregoing preferred embodiments, it should be understood that the depictions above shall not be regarded as limitations to the present disclosure. After those skilled in the art having read the contents above, many modifications and substitutions to the present disclosure are all obvious. Therefore, the protection scope of the present disclosure should be limited by the appended claims.

1. A method for controlling a transmit power of an active depth sensor, comprising procedures of:
obtaining priori information of a to-be-measured working environment;
presetting priori information of the to-be-measured working environment;
working out position information and orientation information of the active sensor based on the preset priori information of the to-be-measured working environment and detected information; and
working out a maximum transmit power based on the position information and the orientation information of the active sensor and correspondingly dynamically adjusting the transmit power of the active depth sensor based on the maximum transmit power.

2. The method for controlling a transmit power of an active depth sensor according to claim 1,
wherein the priori information of the to-be-measured working environment includes:
map information of the working environment,
wherein the map information includes:
geographical information, depth information, and image information of the working environment.

3. The method for controlling a transmit power of an active depth sensor according to claim 1, wherein the detected information refers to feedback information detected in real time by the active sensor.

4. An active sensor for implementing the method for controlling a transmit power of an active depth sensor according to claim 1, comprising:
an acquiring module;
a processing module preset with priori information of a to-be-measured working environment; and
a control module connected to the acquiring module and the processing module, respectively;
wherein the acquiring module is configured for obtaining, in real time, detected information of the to-be-measured working environment, and sending the detected information to the processing module;
the processing module is configured for working out position information and orientation information of the active sensor based on the preset priori information of the to-be-measured working environment and the detected information, working out a maximum transmit power based on the position information and the orientation information of the active sensor, and sending the maximum transmit power to the control module; and the control module is configured for correspondingly dynamically adjusting the transmit power of the active depth sensor based on the maximum transmit power.

5. The active depth sensor according to claim 4, wherein the active sensor is applicable to a robot, an unmanned drive, and smart hardware.

6. A detection system, comprising:
at least one active sensor;
a memory;
one or more processors; and
one or more programs, wherein the one or more programs are stored in the memory and configured to cause the one or more processors to perform the following steps:
obtaining priori information of a to-be-measured working environment;
presetting priori information of the to-be-measured working environment;
working out position information and orientation information of the active sensor based on the preset priori information of the to-be-measured working environment and detected information; and
working out a maximum transmit power based on the position information and the orientation information of the active sensor and correspondingly dynamically adjusting the transmit power of the active depth sensor based on the maximum transmit power.
